(19) United States
(12) Patent Application Publication
(10) Pub. No.: US 2002/0025404 A1
(43) Pub. Date: Feb. 28, 2002

(54) Pre-formed honeycomb protector

(76) Inventors: Thomas T. Taber, Park Ridge, IL (US); Robert E. Jaegers, Lake Zurich, IL (US); Christopher J. Bleries, Gurnee, IL (US); Michael L. Napson, Columbia, SC (US)

Correspondence Address: JENKENS & GILCHRIST, PC, 1445 ROSS AVENUE, SUITE 3200, DALLAS, TX, 75202, US

(21) Appl. No.: 09/877,282

(22) Filed: Jun. 7, 2001

Related U.S. Application Data
(60) Provisional application No. 60/209,864, filed on Jun. 7, 2000.

(51) Int. Cl. B32B 3/12

(52) U.S. Cl. 428/118; 493/59

(57) ABSTRACT

A pre-formed honeycomb protector for protecting the edges of articles during shipping is disclosed. The honeycomb protector of the present invention comprises a panel including a honeycomb core having a plurality of abutting cells defining a plurality of abutting top and bottom hollow cell faces respectively. A bottom face sheet is secured over and abutting the bottom hollow cell faces of the honeycomb core and a top face sheet is secured over and abutting the top hollow cell faces of the honeycomb core. The honeycomb panel is crushed or cut so as to be made foldable. Adhesive is then applied to the surfaces exposed by the crushing or cutting, and the resulting two folding panels separated by the crushed or cut area are folded inward to form an “L” shaped edge protector.

The present application claims priority to provisional application serial No. 60/209,864.

### FIELD OF THE INVENTION

The present invention generally relates to a protector for articles to be packaged and more particularly relates to a pre-formed honeycomb protector provided ready for use at packaging sites.

### BACKGROUND OF THE INVENTION

The use of protectors for edges of articles during shipping is well known in the packaging industry. Edges and comers of articles such as electronics, appliances, furniture, doors, and other items must be protected during shipment to avoid damage to the items during handling and shipment.

One type of edge protector currently used in the packaging industry comprises a panel including a paper honeycomb core disposed between face sheets. The panel is provided in a flat form at packaging sites and is folded into the desired protecting shape at the packaging sites. This type of protector requires extra labor at the shipping site, increasing the difficulty of preparing items for shipment. In addition, folding flat panels at the site of shipment is ergonomically taxing on workers, who must make repetitive movements to form the flat panels into edge protectors.

Thus, there exists a need in the packaging industry for edge protectors that are pre-formed and provided to shipping and packaging sites in a ready-to-use format.

### SUMMARY OF THE INVENTION

The present invention is a pre-formed honeycomb protector for protecting the edges of articles during shipping. The honeycomb protector of the present invention comprises a panel including a honeycomb core having a plurality of abutting cells defining a plurality of abutting top and bottom hollow cell faces respectively. A bottom face sheet is secured over and abutting the bottom hollow cell faces of the honeycomb core and a top face sheet is secured over and abutting the top hollow cell faces of the honeycomb core.

To form the honeycomb panel into an edge protector according to one embodiment the present invention, a “V” shaped cut is made through the top face sheet and into the honeycomb core. The cut extends downward toward the bottom face sheet. Adhesive is then applied to the surfaces exposed by the “V” shaped cut, and the resulting two folding panels separated by the “V” shaped cut are folded inward to form an “L” shaped edge protector. Alternatively, a “V” shaped crushed region may be crushed into the core from above before adhesive is applied and the panels are folded.

In one preferred embodiment, the honeycomb panel is simultaneously fed through two parallel cutting mechanisms. Two “V” shaped cuts are made in the honeycomb panel, resulting in a central panel and two side panels. Adhesive is applied to the surfaces exposed by the two “V” shaped cuts, and the side panels are folded upward. The resulting “U” shaped part may be used as a “U” shaped protector or may be split into two “L” shaped protectors. In an alternative embodiment, the parallel “V” shaped cuts are replaced with parallel “V” shaped crushed regions to which adhesive is applied. Similarly to the cut embodiment, the crushed regions serve as hinges for folding the panel into an edge protector.

It is preferred for the cut or crushed area to have an angle of about 90 degrees, so that the resulting edge protector is suited to protect edges having right angles. Other angles of protectors, however, may be made according to the present invention by cutting or crushing the honeycomb panel to result in a cut or depression with an interior angle of greater than or less than 90 degrees.

Other advantages and features of the present invention will be apparent from the following detailed description of the preferred embodiments of the invention, the drawings, and the appended claims.

### BRIEF DESCRIPTION OF THE DRAWINGS

In the accompanying drawings:

FIG. 1 is a perspective view of a honeycomb panel comprising a honeycomb core with an attached bottom face sheet and an attached top face sheet;

FIG. 2 is a perspective view of a honeycomb panel having a “V” shaped cut;

FIG. 3 is a perspective view of a honeycomb panel having two “V” shaped cuts;

FIG. 4 is a perspective view of an “L” shaped edge protector according to one embodiment of the present invention,

FIG. 5 is a perspective view of a “U” shaped edge protector according to one embodiment of the present invention;

FIG. 6 is a side perspective view of a “U” shaped edge protector according to one embodiment of the present invention,

FIG. 7 is a side perspective view of an “L” shaped edge protector according to one embodiment of the present invention;

FIG. 8 is a dimensional view of an “L” shaped edge protector according to one embodiment of the present invention; and

FIG. 9 is a dimensional view of a “U” shaped edge protector according to one embodiment of the present invention.

### DESCRIPTION OF THE PREFERRED EMBODIMENTS

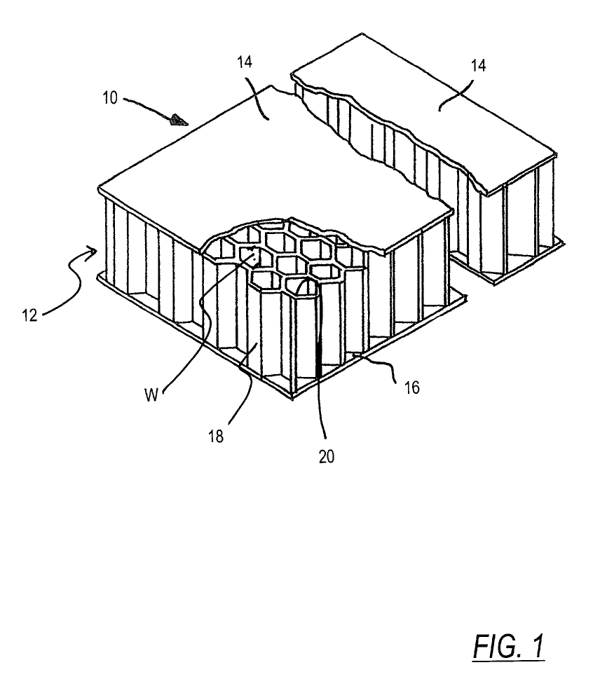

The edge protector of the present invention is constructed using a honeycomb panel. Turning to FIG. 1, a honeycomb panel 10 is shown wherein a honeycomb core 12 is sandwiched between a top face sheet 14 and a bottom face sheet 16. The honeycomb core 12 comprises a plurality of abutting partition walls 18 which extend generally perpendicularly between the top and bottom face sheets 14 and 16 respectively. The partition walls 18 form a plurality of abutting elongate hexagonal cells 20 having opposed bottom and top hollow-cell hexagonal faces on opposite sides of the honeycomb core 12. The top face sheet 14 and the bottom face sheet 16 are respectively abutted to the top and bottom hexagonal faces of the core 12.

Preferably, the honeycomb core 12 and the top and bottom face sheets 14 and 16 are made of a kraft paper. The face sheets 14 and 16 can be made of various weights of material, ranging from 26 pound paper or linerboard to 90 pound paper or linerboard, and may be made of two different weights of paper or linerboard. Alternatively, one or both of the face sheets 14 and 16 may be made of chip board, a heavier duty paper product than 90 pound linerboard. The core material may likewise be made of a variety of materials and weights, with 26 pound and 33 pound paper or liner board being preferred. Further, the hexagonal cells 20 have an internal width “W” ranging from about ⅜ of an inch to about 1.2 inches. Materials other than paper, linerboard, or chip board can also be used for the face sheets 14 and 16 and the honeycomb core 12.

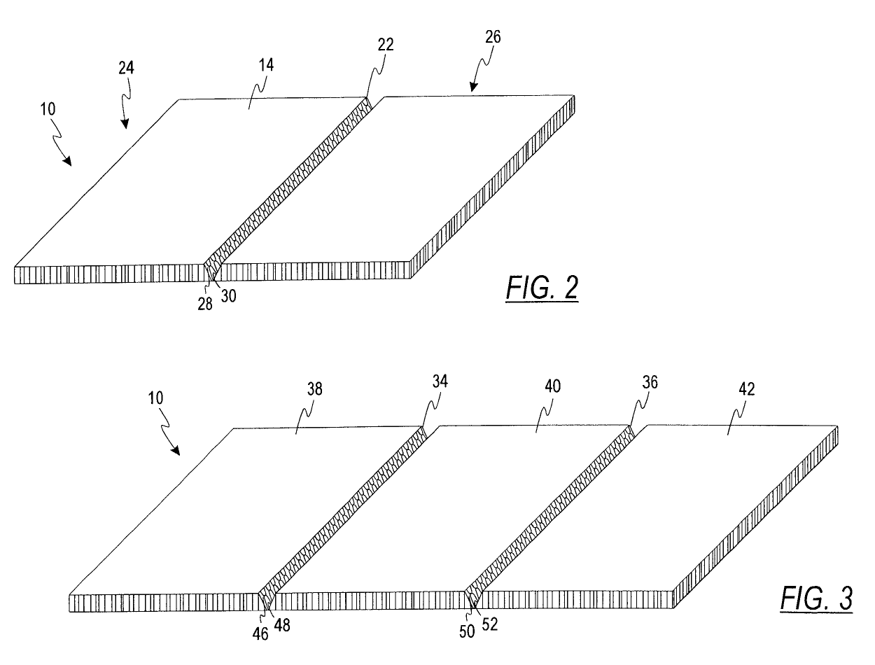

Turning now to FIG. 2, the honeycomb panel 10 is shown with a 90 degree “V” shaped cut 22 through the top face sheet 14 and into the honeycomb core 12. In one preferred embodiment, the cut is made with a “V” shaped dado blade as known in woodworking, and dust resulting from the cut is removed with a dust removal system. Alternatively, the cut may be made with a mitre saw or other cutting instrument or a crushed area may be crushed into the panel. The “V” shaped cut 22 separates the honeycomb panel 10 into first and second folding panels 24 and 26 respectively. The “V” shaped cut 22 further creates first and second exposed core areas 28 and 30 respectively.

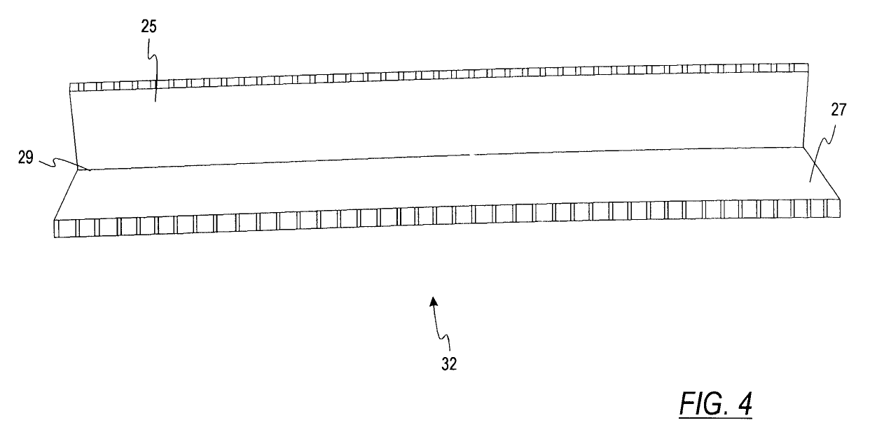

To form an “L” shaped edge protector 32 as shown in FIG. 4, adhesive is applied to the first and second exposed core areas 28 and 30 and the first folding panel 24 and second folding panel 26 are folded toward each other. As a result, the first and second exposed core areas 28 and 30 approach each other and join, with the applied adhesive sandwiched between the exposed core areas 28 and 30. The exposed core areas 28 and 30 are thus adhesively attached upon the curing of the adhesive and the “L” shaped edge protector 32 is provided with rigidity and is unlikely to break apart easily. The first folding panel 24 becomes a first protector panel 25 and the second folding panel 26 becomes a second protector panel 27. The two panels are joined along the area of juncture 29. In one preferred embodiment, the adhesive is a combination of hot melt and cold adhesive, which is known to provide a strong but quick bond along the area of juncture 29. In one alternative embodiment, adhesive is applied to only one of the first and second exposed core areas 28 and 30 before the panel is folded as described.

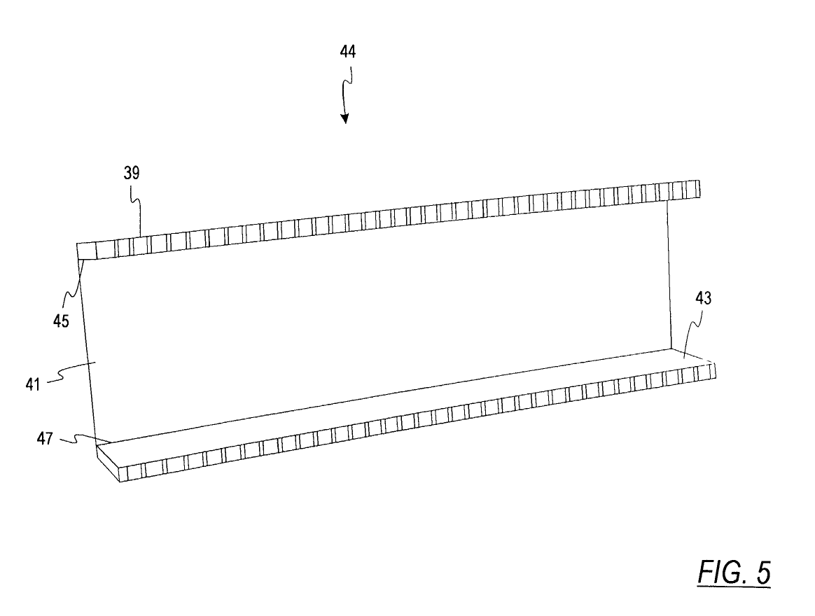

Turning now to FIG. 3, one preferred embodiment is shown wherein a honeycomb panel 10 is provided with two approximately parallel 90 degree “V” shaped cuts 34 and 36. This results in the formation of a first side panel 38, a central panel 40, and a second side panel 42. This embodiment may be used to form a “U” shaped protector 44 as shown in FIG. 5. In this embodiment, the “V” shaped cuts 34 and 36 result in exposed core areas 46, 48, 50, and 52. To form the “U” shaped protector 44, adhesive is applied to the exposed core areas 46, 48, 50, and 52, and the first side panel 38 and second side panel 42 are folded upward toward the central side panel 40. This results in the exposed core areas 46 and 48 approaching each other and sandwiching the adhesive, as well as exposed core areas 50 and 52 likewise approaching each other and sandwiching the adhesive. In one alternative embodiment, adhesive is applied to only one of the exposed core areas 46 and 48 and to only one of exposed core areas 50 and 52 before the panel is folded as described.

When the adhesive cures after the folding process, the “U” shaped protector 44 (shown in FIG. 5) is formed. The first side panel 38 becomes a first side protector panel 39, the central panel 40 becomes a central protector panel 41, and the second side panel 42 becomes the second side protector panel 43. The first side protector panel 39 and the central protector panel 41 are connected along a first area of juncture 45. Likewise, the second side protector panel 43 and the central protector panel 41 are connected along a second area of juncture 47.

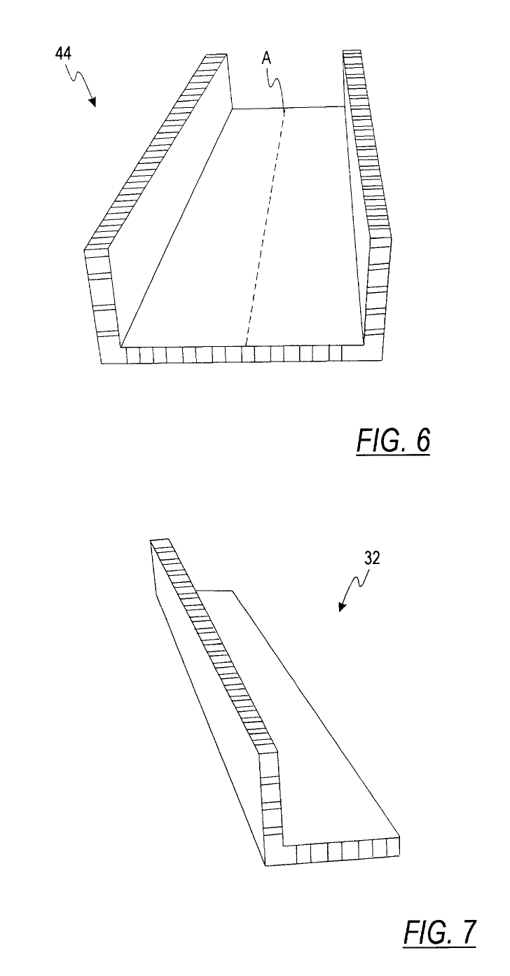

Turning now to FIG. 6, the “U” shaped protector 44 may be used in its “U” shaped formation for protecting articles such as doors, which require close parallel edges to be protected. Alternatively, a “U” shaped protector 44 may be cut, for example, along line “A” into two “L” shaped protectors. An example of a resulting “L” shaped protector 32 is shown in FIG. 7.

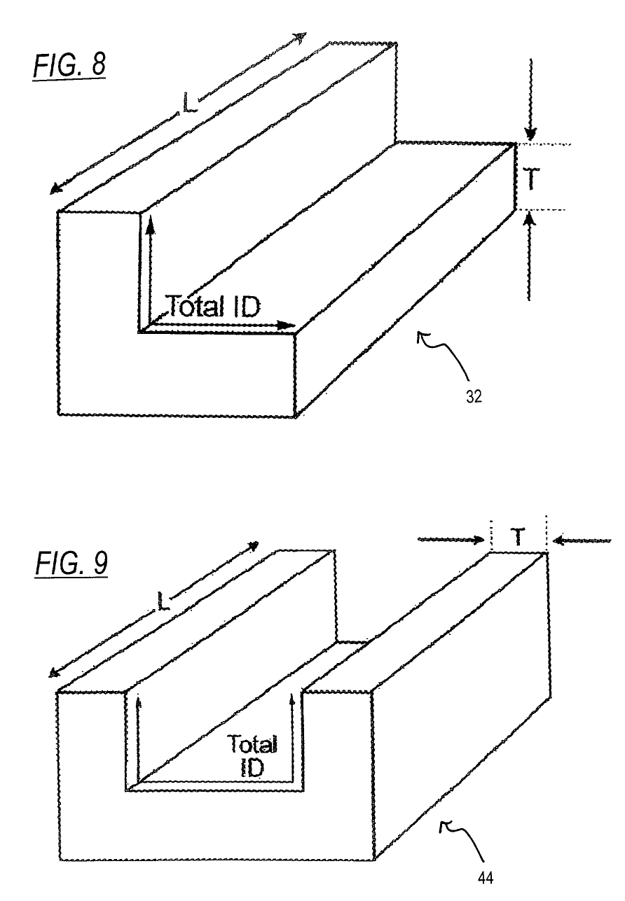

Edge protectors according to the present invention may be manufactured to a variety of user specifications. Turning now to FIG. 8, a dimensional view of an “L” shaped protector 32 is shown. The “L” shaped protector 32 has length “L”thickness “T” and total internal dimension “Total ID.” “L” shaped protectors 32 may be formed with a wide variety of thicknesses depending on the desired application, with preferred thicknesses ranging from about 0.5 inches to about 2 inches. A wide range of total internal dimensions is likewise possible, with preferred total internal dimensions ranging from about 4 inches to about 12 inches. The lengths available are wide-ranging and are dependent upon the item being packaged. Possible lengths may range from a few inches to four feet or longer.

Turning now to FIG. 9, a dimensional view of a “U” shaped protector 44 is shown. The “U” shaped protector 44 has length “L” thickness “T” and total internal dimension “Total ID.” “U” shaped protectors 44 may be formed with a wide variety of thicknesses depending on the desired application, with preferred thicknesses ranging from about 0.5 inches to about 2 inches A wide range of total internal dimensions is likewise possible, with preferred total internal dimensions ranging from about 5 inches to about 24 inches. Lengths for the “U” shaped protector are wide-ranging and are dependent upon the item being packaged. Possible lengths range from a few inches to four feet or longer.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. An edge protector comprising:
a first protector panel comprising a honeycomb core sandwiched between top and bottom first protector panel face sheets; and
a second protector panel comprising a honeycomb core sandwiched between top and bottom second protector panel face sheets;
wherein said first protector panel and said second protector panel are adhesively connected along an area of juncture.

2. The edge protector of claim 1 wherein said bottom first protector panel face sheet and said bottom second protector panel face sheet are constructed of a single piece of face sheet material.

3. The edge protector of claim 1 wherein said area of juncture comprises a “V” shaped cut area.

4. The edge protector of claim 1 wherein said area of juncture comprises a “V” shaped crushed area.

5. The edge protector of claim 1 wherein said area of juncture comprises two inner surfaces having exposed honeycomb cells adhesively connected to each other.

6. An edge protector comprising:
a first side protector panel comprising a honeycomb core sandwiched between top and bottom first side protector panel face sheets;
a central protector panel comprising a honeycomb core sandwiched between top and bottom central protector panel face sheets; and
a second side protector panel comprising a honeycomb core sandwiched between top and bottom second side protector panel face sheets;
wherein said first side protector panel and said central protector panel are adhesively connected along a first area of juncture and said second side protector panel and said central protector panel are adhesively connected along a second area of juncture.

7. The edge protector of claim 6 wherein said bottom first side protector panel face sheet, said bottom central protector panel face sheet, and said bottom second side protector panel face sheet are constructed of a single piece of face sheet material.

8. The edge protector of claim 6 wherein said first area of juncture and said second area of juncture each comprise a “V” shaped cut area.

9. The edge protector of claim 6 wherein said first area of juncture and said second area of juncture each comprise a “V” shaped crushed area.

10. The edge protector of claim 6 wherein said first area of juncture and said second area of juncture each comprise a shaped crushed area or shaped cut area with an interior angle of greater than, less than, or equal to 90 degrees.

11. The edge protector of claim 6 wherein said area of juncture comprises two inner surfaces with exposed honeycomb cells adhesively connected to each other.

12. An edge protector comprising:
a first side protector panel comprising a honeycomb core sandwiched between top and bottom first side protector panel face sheets;
a central protector panel comprising a honeycomb core sandwiched between top and bottom central protector panel face sheets; and
a second side protector panel comprising a honeycomb core sandwiched between top and bottom second side protector panel face sheets;
wherein said honeycomb core consists of abutting elongated hexagonal cells containing partition walls which extend generally perpendicularly between the top and bottom face sheets;
wherein said first side protector panel and said central protector panel are connected along a first area of juncture with adhesive and said second side protector panel and said central protector panel are connected with adhesive along a second area of juncture; and
wherein said adhesive consists of a combination of hot melt and cold adhesive which cures after the folding process of said first side protector panel and said second side protector panel towards said central protector panel.

13. A method for forming a honeycomb edge protector comprising:
providing a honeycomb panel;
cutting a cut in said honeycomb panel so as to expose first and second exposed core areas and create first and second folding panels; applying adhesive to said first and second exposed core areas; and
folding said first and second folding panels toward each other so as to capture said adhesive between said first and second exposed core areas.

14. The method of claim 13 wherein said step of cutting a cut comprises cutting a “V” shaped cut.

15. The method of claim 13 wherein said step of cutting a cut comprises cutting an interior 90 degree angle.

16. A method for forming a honeycomb edge protector comprising:
providing a honeycomb panel;
cutting a first “V” shaped linear cut in said honeycomb panel so as to expose first and second exposed core areas and create a first side panel;
cutting a second “V” shaped linear cut approximately parallel to said first “V” shaped linear cut so as to expose third and fourth exposed core areas and create a central panel and a second side panel;
applying adhesive to said first, second, third, and fourth exposed core areas;
folding said first side panel toward said central panel so as to capture said adhesive between said first and second exposed core areas; and
folding said second side panel toward said central panel so as to capture said adhesive between said third and fourth exposed core areas.

17. The method of claim 16 wherein said actions of cutting a first “V” shaped linear cut and cutting a second “V” shaped linear cut are performed substantially contemporaneously.

18. A method for forming a honeycomb edge protector comprising:
providing a honeycomb panel;
crushing said honeycomb panel so as to expose a crushed area and create first and second folding panels;
applying adhesive to said crushed area; and
folding said first and second folding panels toward each other so as to capture said adhesive within said crushed area.

19. A method for forming a honeycomb edge protector comprising:
providing a honeycomb panel;
crushing said honeycomb panel so as to expose a first crushed area and create first side panel;
crushing said honeycomb panel so as to expose a second crushed area and create a central panel and a second side panel;
applying adhesive to said first crushed area and said second crushed area;
folding said first side panel toward said central panel so as to capture said adhesive within said first crushed area; and
folding said second side panel toward said central panel so as to capture said adhesive within said second crushed area.

20. A method for forming a honeycomb edge protector comprising:
providing a honeycomb panel;
cutting a first “V” shaped linear cut in said honeycomb panel so as to expose first and second exposed core areas and create a first side panel;
cutting a second “V” shaped linear cut approximately parallel to said first “V” shaped linear cut so as to expose third and fourth exposed core areas and create a central panel and a second side panel;
applying adhesive to said first, second, third, and fourth exposed core areas;
folding said first side panel toward said central panel so as to capture said adhesive between said first and second exposed core areas;
folding said second side panel toward said central panel so as to capture said adhesive between said third and fourth exposed core areas; and
splitting said central panel so as to create two “L” shaped protectors.
